(19) United States
(12) Patent Application Publication
(10) Pub. No.: US 2013/0322473 A1
(43) Pub. Date: Dec. 5, 2013

(54) APPARATUS AND METHOD FOR MEASURING CONTRAST IN A HIGH POWER LASER SYSTEM

(71) Applicant: LOS ALAMOS NATIONAL SECURITY, LLC, LOS ALAMOS, NM (US)

(72) Inventors: SASIKUMAR PALANIYAPPAN, LOS ALAMOS, NM (US); RANDALL P. JOHNSON, LOS ALAMOS, NM (US)

(73) Assignee: LOS ALAMOS NATIONAL SECURITY, LLC, LOS ALAMOS, NM (US)

(21) Appl. No.: 13/907,576

(22) Filed: May 31, 2013

Related U.S. Application Data
(60) Provisional application No. 61/654,630, filed on Jun. 1, 2012.

(51) Int. Cl. H01S 3/10

(52) U.S. Cl. CPC H01S 3/10
USPC 372/21

(57) ABSTRACT

A preferred apparatus can include a high-power laser; a beam splitter; a non-linear optical assembly configured to cube an incident beam; a detector optically configured to receive an input beam from the beam splitter and a reference beam from the non-linear optical assembly; and a controller configured to calculate a fourth order cross correlation of the input beam and the reference beam to characterize the high-power laser.

### CLAIM OF PRIORITY

The present application claims priority to U.S. Provisional Patent Application Ser. No. 61/654,630 filed on 1 Jun. 2012 and entitled “Apparatus and Method for Measuring Contrast in a High Power Laser System,” the entirety of which is incorporated herein by this reference.

### STATEMENT REGARDING FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### TECHNICAL FIELD

The invention generally relates to the field of optics and photonics, and more particularly to the field of contrast measurement in high-powered laser systems.

### BACKGROUND AND SUMMARY

Recent developments in the study of relativistic laser-matter interaction is made possible by modern table-top multi-terawatt and petawatt class lasers providing a focused laser intensity of >10¹⁸ W/cm². However at these high laser intensities the foot/pedestal of the laser pulse residing at many orders below the laser peak contains enough intensity (>10¹² W/cm²) to significantly modify the target conditions well before the laser peak arrives at the target. The foot/pedestal of the laser pulse largely arises from Amplified-Spontaneous-Emission (ASE), pre-pulses from multiple round trips inside the laser cavity and post-pulses wrapping around as pre-pulses due to non-linear phase (B-integral) in the gain medium. Suppression of the laser pre-pulses and the pedestal level is absolutely vital, which otherwise could lead to undesired long column of underdense plasma in front of the target. A first step in this regard is to measure the laser contrast over high dynamic range and large temporal window within a single laser shot as these high-power lasers typically produce one laser pulse per hour. Even for high-repetition rate lasers, a single-shot laser contrast measurement is required to quantify the shot-to-shot contrast fluctuation.

Extensive experimental effort has been devoted to laser pulse characterization within a single laser shot either directly in the temporal domain or indirectly in the spectral domain. In the temporal domain Frequency-Resolved-Optical-Gating (FROG) and third order auto-correlator are widely used for single-shot laser pulse characterization. Specifically, a single-shot third order auto-correlator using a pulse replicator has been demonstrated to measure the laser contrast with 60 dB dynamic range and 200 ps temporal window. While this technique has been demonstrated at the laser front-end where laser pulses with 5 Hz repetition rate was available, the complexity of creating numerous pulse replicas and aligning them with great care makes it difficult to deploy it at the final stage of the laser amplifier chain, where laser repetition rate is typically one shot per hour. On the other hand, numerous flavors of spectral interferometry such as Spectral-Shearing-Interferometry (SSI), Spectral-Phase-Interferometry-for-Direct-Electric field-Reconstruction (SPIDER) and Self-Referencing-Spectral-Interferometry (SRSI) have also been used for laser pulse characterization within a single laser shot in the spectral domain using an additional self-created reference pulse. In spectral interferometry, a self-created reference pulse combined with the original laser pulse creates a spectral interferogram, which contains the laser pulse information. The spectral interferogram is then Fourier-transformed into the temporal domain, where the so called AC and DC components are isolated for further analysis to extract the laser pulse information.

Specifically, SRSI has been successfully demonstrated to measure the laser pulse shape with 50 dB dynamic range within ±0.4 ps temporal window. While SRSI is a very powerful method to measure the laser contrast over high dynamic range in a single shot, its practical application is potentially limited due to at least the following technical constraints. First, the AC and DC component signals are present in the entire temporal window in the Fourier-transformed spectral interferogram, a reliable truncation of these signals largely limits the dynamic range and the temporal window of the measurement. Second, even if reliable separation of the DC and AC components is achieved, the reference pulse is initially assumed to have flat temporal phase, which is then fed into an iterative algorithm to remove the approximation. The iterative algorithm, in principle, is expected to converge and to provide exact laser pulse characterization without any approximation, which is however lacking in demonstration. A third concern in SRSI is using cross-polarized-wave (XPW) to create a reference pulse, which being a third order (χ³) non-linear process requires a laser intensity of 10¹¹-10¹² W/cm². This could lead to fluence damage of the crystal and/or self-focusing degradation of the beam quality. Finally, XPW relies on a polarizer with high extinction ratio (>50 dB) to isolate the reference pulse from the original pulse, which sets an upper limit on the dynamic range of the measurement.

Accordingly, preferred embodiments of the present invention can include an apparatus and method for improved spectral interferometry using a fourth order crosscorrelator. The preferred embodiments of the present invention are configured to measure the laser contrast with 70 dB dynamic range over 50 ps temporal window containing measurement artifacts. The preferred embodiments of the present invention do not require separation of AC and DC components and fine fringes in the spectral interferogram; thus making the measurement practical. Furthermore, in variations of the preferred apparatus and method, the reference pulse is created from two consecutive χ² processes in a non-collinear geometry rather than a single χ³ process of XPW in a collinear geometry; making the reference pulse creation more reliable and eliminating the restrictions imposed by the high extinction ratio polarizer. Finally, other variations of the preferred apparatus and method can employ a Fourier-transformation to obtain the laser contrast; eliminating the need for a complicated iterative algorithm. These and other aspects, advantages, and salient features of the preferred embodiments of the present invention are described in detail below with reference to the following Figures.

### BRIEF DESCRIPTION OF THE FIGURES

FIG. 1 is a schematic diagram of an apparatus for measuring contrast in a high-power laser system in accordance with a preferred embodiment.

FIG. 2 is a flowchart depicting a method for measuring contrast in a high-power laser system in accordance with a preferred embodiment.

FIG. 3 is a schematic diagram of an example apparatus for measuring contrast in a high-power laser system in accordance with one variation of the preferred embodiment.

FIG. 4 is a graphical representation of experimental data derived from the example apparatus shown in FIG. 3.

FIG. 5 is a graphical representation of experimental data derived from the example apparatus shown in FIG. 3.

FIG. 6 is a graphical representation of experimental data derived from the example apparatus shown in FIG. 3.

### DETAILED DESCRIPTION OF THE PREFERRED EMBODIMENTS

The following description of the preferred embodiments of the present invention and variations thereof is made with reference to the Figures and one or more illustrative example configurations and/or implementations. Those of skill in the art will recognize that the following description is for illustrative purposes only, and that the scope of the present invention is defined exclusively by the following claims.

### Preferred System and Method

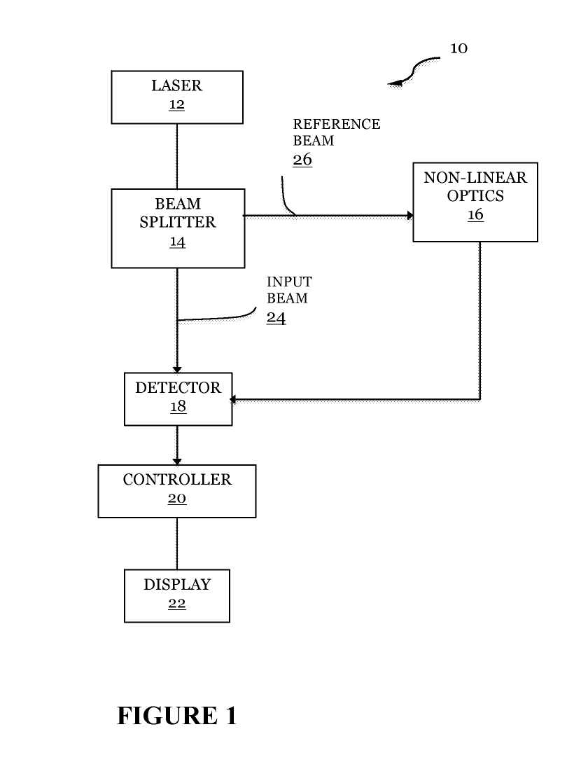

As shown in FIG. 1, an apparatus 10 according to a preferred embodiment can include a laser 12 generating a beam, pulse, or ray of laser light for analysis and/or characterization. The preferred apparatus 10 can further include a beam splitter 14 configured to direct an input beam 24 to a detector 18 and a reference beam 26 to a non-linear optical assembly 16. As shown in FIG. 1, the preferred apparatus 10 can further include a detector 18 optically arranged to receive the input beam 24 and/or the reference beam 26 in a simultaneous or substantially simultaneous manner. The preferred apparatus 10 can further include a controller connected to the detector 20 and configured to process any electrical signals generated at and/or by the detector 20 upon receipt of the input beam 24 and/or the reference beam 26. The preferred apparatus 10 can further include a display 22 and/or other user interface elements (i.e., keyboard, mouse, trackpad, audio/video I/O) as desired for directing the captured and/or analyzed data to a human user. The apparatus 10 preferably functions to characterize the laser 12 output in one or both of the time or frequency domains to achieve high dynamic range contrast information about the laser 12 output in order to better understand and quantify relativistic laser-matter interactions.

As shown in FIG. 1, the preferred apparatus 10 can include a laser 12 that preferably functions to generate a pulse having a predetermined frequency and intensity. A preferred laser 12 can include a high-power laser capable of generating on the order of 10²⁰ W/cm² intensity per pulse. Such a preferred laser 12 will be of sufficient intensity to have a pedestal capable of significant target modification. As an example, although the pedestal intensity can be orders of magnitude less than that of the main pulse (i.e., 10¹² W/cm²), such a large intensity can still change the properties of the target prior to arrival of the main pulse. A suitable laser 12 can include for example a neodymium glass laser (silicate or phosphate glasses), a titanium sapphire laser, or any other high power solid state or chemical laser.

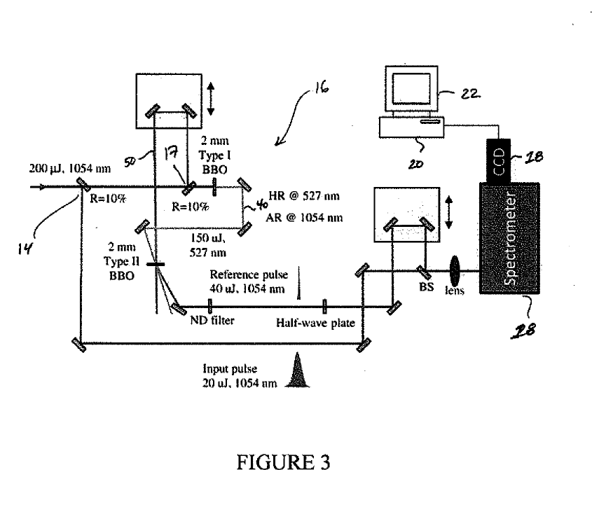

As shown in FIG. 1, the preferred apparatus 10 can further include a beam splitter 14 optically configured to divide the laser 12 output into two or more portions, such as for example the input beam 24 and the reference beam 26. In one example configuration shown in FIG. 3, the beam splitter 14 is preferably a 10/90 beam splitter, although any suitable fractional division of the laser 12 output can be selected. The beam splitter 14 preferably directs the reference beam 26 to a non-linear optical assembly 16 that is configured to generate a frequency matched laser pulse for cross-correlation with the input beam 24. As shown in the example configuration of FIG. 3, the non-linear optical assembly 16 preferably includes a 10/90 beam splitter 14 receiving a laser output pulse from a Nd-glass laser at approximately 200 μJ, 1054 nm, 400 fs, 5 Hz. As shown, the 90% transmitted pulse (i.e., reference beam 26) can preferably be used to create a reference pulse via using self-pumping-optical-parametric-amplification. Preferably, a second 10/90 beam splitter 17 can be used to reflect the 10% of the reference beam 26 while 90% of the reference beam 26 can be transmitted and consecutively frequency doubled in a 2 mm thick type I BBO crystal with 150 μJ output at 527 nm. The residual collinear input pulse at 1054 nm from the type I BBO crystal can preferably be further attenuated by three consecutive dichroic mirrors with high reflectance at 527 nm and anti-reflection coated at 1054 nm. Preferably, the frequency doubled pump pulse 40 can be combined with the 10% reflected signal pulse 50 from the second beam splitter 17 with an adjustable time delay in a 2 mm thick type II BBO crystal in low gain regime in non-collinear configuration to amplify the signal pulse 50 via optical-parametric-amplification. This in turn preferably produces a residual idler pulse at same wavelength as the signal pulse at 1054 nm, which is used as the reference beam 26 at the detector 20. The reference beam 26 preferably has a much shorter pulse duration and better contrast than the input beam 24 as the intensity profile of the former is a cube of the original input beam 24 profile.

As shown in FIG. 1, the preferred apparatus 10 can include a detector 18 configured to receive and characterize one or both of the input beam 24 and the reference beam 26. In operation, preferably the input beam 24 and the reference beam 26 are combined and focused at the entrance of the detector 18. Preferably, the detector 18 can include at least a spectrometer and a CCD photodetector. A suitable spectrometer can include 1200 lines/mm grating blazed at 500 nm with 10 μm slit width using an f/10 focusing lens. The f/# of the final focusing lens is preferably comparable to the f/# of the spectrometer (f/8) to obtain better spectral resolution. A preferred spectrometer can provide a spectral dispersion of 1.6 nm/mm with spectral resolution of 0.01 nm for 10 μm slit width. The spectral interferogram can preferably be captured with a cooled silicon CCD with a 2D-array of 3326×2504 pixels (pixel size of 5.4 μm×5.4 μm). The example CCD calibration yields 0.008 nm spectral bandwidth per pixel, which is very close to the spectrometer resolution of 0.01 nm. The variation of CCD spectral sensitivity can preferably be accounted for in the measurement by using an incandescent or other suitable light source.

As shown in FIG. 1, the preferred apparatus 10 can include a controller 20 configured to process the signals, characterizations, and/or data generated at the detector 18. The controller 20 can be configured as a desktop computer, server, smart phone, tablet computer, netbook, or any other device having computing hardware adapted to process and/or response to computer-based instructions through computer-readable media (e.g., non-transitory volatile or non-volatile memory components). The controller 20 can be further configured as any suitable combination of hardware, firmware, and/or software suitable for executing computer-readable media, and can further include specialized computing hardware such as an integrated circuit, a programmable logic device, and/or a field programmable gate array.

Preferably, the controller 20 can be configured to employ the convolution theorem of Fourier transformation, which states that a point-wise multiplication of spectrums from two different pulses in the spectral domain is equivalent to their convolution or cross-correlation in temporal domain. Accordingly, the preferred apparatus 10 functions to measure the point-wise multiplication of the input beam 24 spectrum and the reference beam 26 spectrum in the spectral domain, which is then Fourier transformed into the time-domain to obtain the cross-correlation between the input beam 24 and the reference beam 26. As described above, the reference beam 26 is preferably obtained by essentially cubing a fraction of the input laser pulse intensity using two non-linear crystals. As such, the controller 20 preferably functions to measure the cross-correlation of the original laser input beam 24 with its own cubed reference beam 26, which is a fourth order cross-correlation of the original laser 12 output.

Mathematically, E(t) and E_{ref}(t) are the complex-electric fields of the input and reference beams 24, 26 respectively. The measured spectral interferogram with a given time delay τ between the input and reference beams 24, 26 can be expressed as follows:

S(ω)=|E(ω)+E_{ref}(ω)e^{iωτ}|²=|E(ω)|²+|E_{ref}(ω)|²+E_{ref}(ω)E*(ω)e^{iωτ}+E*_{ref}(ω)E(ω)e^{-iωτ} (1).

Equation (1) contains four components in it viz., the input pulse spectral intensity, the reference pulse spectral intensity, the point-wise spectral product of the input and reference pulses and its complex conjugate. A direct Fourier-transforming of the measured spectral interferogram into temporal domain yields:

S(t)=E*_{ref}(−t)\textcircled{×}E_{ref}(t)+E*(−t)\textcircled{×}E(t)+E_{ref}(t−τ)\textcircled{×}E(t−τ)+E*_{ref}(−t−τ)\textcircled{×}E*(−t−τ) (2).

In equation (2), the first and second terms are transform-limited second order autocorrelation functions of reference and input beams 24, 26 respectively centered at time zero, referred to as the DC term. The DC term originates from the first and second terms in equation (1) which contain only the spectral amplitude information of the laser pulses without any corresponding phase information. This leads to the DC terms being transform-limited second order autocorrelation of the input and the reference beams 24, 26. The third and fourth terms of equation (2) are the delayed cross-correlation functions between the input and reference beams 24, 26 centered at τ and −τ respectively, referred to as the AC terms. Since the reference beam 26 temporal intensity is just a cube of the input beam 24 intensity, the third and fourth terms in equation (2) are in fact fourth-order cross-correlation of the input beam 24. The AC terms originate from the third and fourth terms in equation (1) which contain the spectral phase difference between the input beam 24 and the reference beam 26 in addition to their spectral amplitude information. This leads to the AC terms being the fourth order cross-correlation of the original laser 12 output. Preferably, the controller 20 selects the first AC term appearing at an earlier time delay as an equivalent fourth-order cross-correlation measurement of the input pulse with high dynamic range. Since the AC terms are mirror replicas of each other, the second AC term appearing at a later time delay can preferably also be equivalently considered to represent the laser pulse contrast measurement. In other variations of the preferred apparatus 10, a step mirror and/or an imaging spectrometer can be included to minimize any artifacts generated in the measurement of the laser contrast, such as for example artifacts generated in the cross-correlation described above.

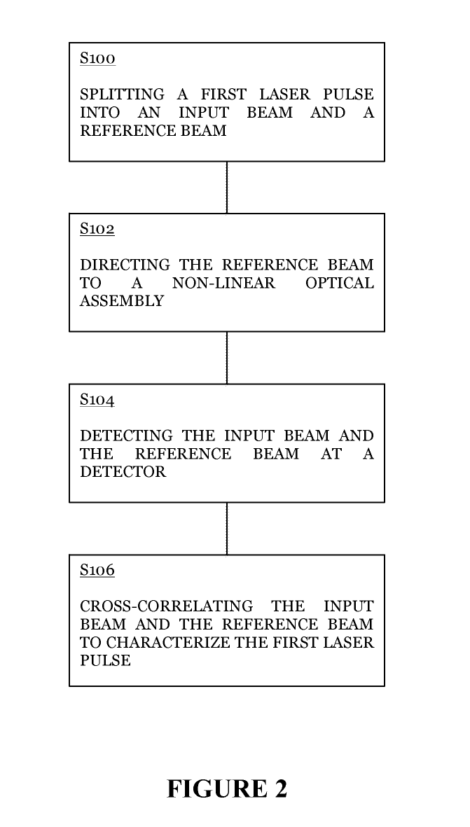

As shown in FIG. 2, a method of a preferred embodiment can include splitting a first laser pulse into an input beam and a reference beam in block S100; directing the reference beam to a non-linear optical assembly in block S102; detecting the input beam and the reference beam at a detector in block S104; and cross-correlating the input beam and the reference beam to characterize the first laser pulse. The method preferably functions to characterize the first laser pulse in one or both of the time or frequency domains to achieve high dynamic range contrast information about the laser in order to better understand and quantify relativistic laser-matter interactions.

As shown in FIG. 2, the preferred method can include block S100, which recites splitting a first laser pulse into an input beam and a reference beam. Block S100 preferably functions to divide the first laser pulse into two or more portions for comparison and/or correlation at a later time. Block S100 is preferably performed by a beam splitter of the type described above, such as a 10/90 beam splitter. Block S102 of the preferred method can include directing the reference beam to a non-linear optical assembly. Block S102 preferably functions to cause the reference beam to be combined with itself in two locations using non-linear optical elements thereby essentially cubing the input beam. Suitable non-linear optical elements can include for example types I and II BBO crystals, partially/totally reflective mirrors, frequency-selecting optical elements, lenses, gradients, and/or any other suitable combination thereof. Preferably, the non-linear optical assembly can include additional elements to combine the input beam and the reference beam into a single beam for output to a detector. The example configuration of a non-linear optical assembly is described above with reference to FIG. 3 can readily be employed in any block or action of the preferred method.

As shown in FIG. 2, the preferred method can further include block S104, which recites detecting the input beam and the reference beam at a detector. Block S104 preferably functions to receive, analyze, determine, calculate, and/or detect the energy from the input beam and the reference beam and to convert the received stimulus into usable and processable data. A suitable detector can include at least a spectrometer and a CCD photodetector. As noted above, a suitable spectrometer can include 1200 lines/mm grating blazed at 500 nm with 10 μm slit width using an f/10 focusing lens. Furthermore, the f/# of the final focusing lens preferably can be comparable to the f/# of the spectrometer (f/8) to obtain better spectral resolution. A preferred spectrometer can provide a spectral dispersion of 1.6 nm/mm with spectral resolution of 0.01 nm for 10 μm slit width. As noted above, the spectral interferogram can preferably be captured with a cooled silicon CCD with a 2D-array of 3326×2504 pixels (pixel size of 5.4 μm×5.4 μm), which yields 0.008 nm spectral bandwidth per pixel, which is very close to the spectrometer resolution of 0.01 nm. The variation of CCD spectral sensitivity can preferably be accounted for in the measurement by using an incandescent or other suitable light source.

As shown in FIG. 2, the preferred method can further include block S106, which recites cross-correlating the input beam and the reference beam to characterize the first laser pulse. Block S106 preferably functions to characterize the first laser pulse in response to the fourth-order cross-correlation of the input beam and the reference beam. Block S106 is preferably performed at or by a controller or processor, which can be configured as any suitable combination of hardware, firmware, and/or software adapted to perform computer-executable code resident on a non-transitory computer-program product. As noted above with respect to Equations (1) and (2), block S106 can preferably include implementing a Fourier transform between the spectral and time domains of the respective pulses. As shown in equation (2), the first and second terms are transform-limited second order autocorrelation functions of reference and input beams respectively centered at time zero (the DC term). As noted above, the DC term originates from the first and second terms in equation (1) which contain only the spectral amplitude information of the laser pulses without any corresponding phase information. The third and fourth terms of equation (2) are the delayed cross-correlation functions between the input and reference beams 24, 26 centered at τ and −τ respectively (the AC term). Since the reference beam 26 temporal intensity is just a cube of the input beam 24 intensity, the third and fourth terms in equation (2) are in fact fourth-order cross-correlation of the input beam 24.

In operation, the preferred apparatus 10 and method measure the laser contrast indirectly in the spectral domain over a 35 dB dynamic range, which is then Fourier transformed into the time domain to obtain the laser contrast over a 80 dB dynamic range. The 45 dB gain in dynamic range by going from spectral domain to temporal domain can be understood from the inverse relation between the spectral domain and the time domain in Fourier transformation. Due to this relation, the 35 dB spectral interferogram measurement contains enough information to produce 80 dB temporal laser contrast information. As such, the preferred apparatus 10 and method can employ a point-wise multiplication of the spectrums from two different pulses in the spectral domain, which is equivalent to their convolution or cross-correlation in the time domain. As noted above, in the preferred apparatus 10 and method, the reference beam is obtained by cubing a fraction of the input laser pulse in time using non-linear optics, through which measurement of the cross-correlation of the original laser pulse is obtained as a fourth order cross-correlator of the input laser pulse.

### Example Implementation

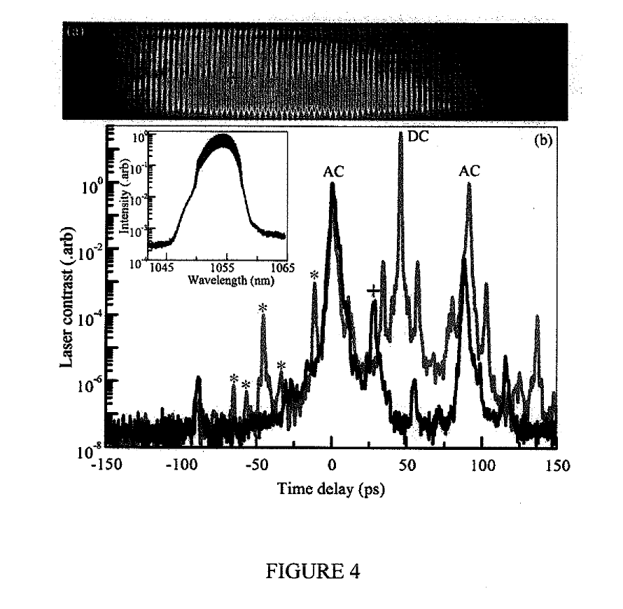

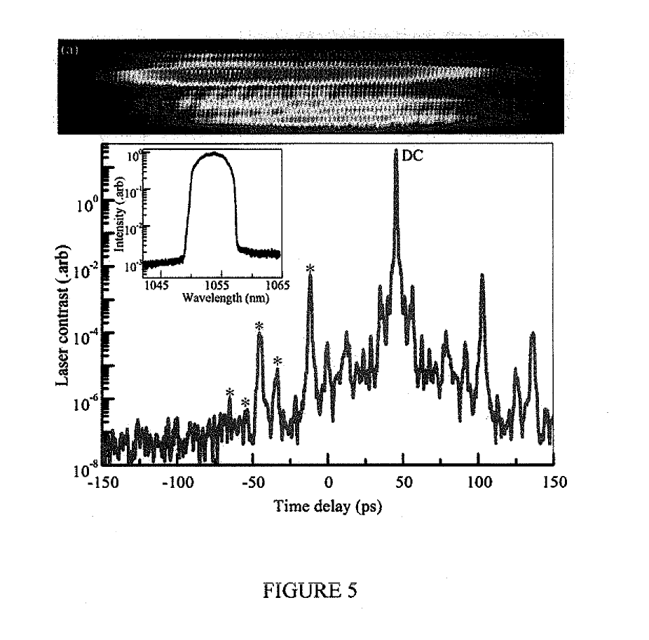

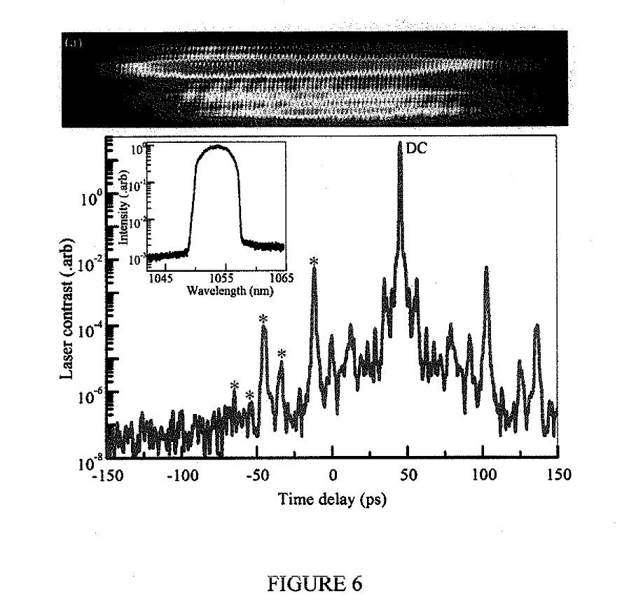

FIGS. 4, 5, and 6 are graphical representations of data derived from the example apparatus 10 described above. FIG. 4(a) shows raw CCD data of the measured spectral interferogram using the example apparatus 10 with the input laser pulse leading the reference pulse by 2.2 ps. FIG. 4(b) shows the laser contrast measurement (solid red line) and multi-shot scanning third order autocorrelator contrast measurement (solid blue line). The FIG. 4 inset shows the spatially averaged line-out of the spectral interferogram in log scale with 35 dB dynamic range. FIG. 5 shows pre-pulse contrast measurement of 80 dB over 250 ps temporal window. The laser pre-pulse contrast initially drops ˜60 dB within 5 ps, followed by another 20 dB drop in the next ˜200 ps. The laser pedestal resides at roughly eight orders of magnitude (10⁻⁸) below the peak of the laser pulse and extends up to −250 ps. The single shot laser contrast measurement from the example apparatus 10 is consistent with the laser contrast measured using a multi-shot scanning third order autocorrelator (Del Mar Photonics). The preferred apparatus 10 can be used to obtain a baseline contrast measurement relatively in a very straight forward manner. FIG. 6 shows data derived from an experiment to calculate the temporal window for the preferred apparatus 10. For the example implementation, the preferred apparatus included a pair of 10% reflectors facing each other and separated by 7.5 mm in the input pulse beam to produce a train of post-pulses 50 ps apart from each other. The train of post pulses will also have a factor of 100 drop in their intensity for every successive pulse. In this case, the reference pulse is made to lead the input pulse by 3.3 ps facilitating the post-pulse contrast measurement. FIG. 6 shows the measured spectral interferogram from the input pulse containing post-pulse trains and the reference pulse. In addition to the spectral fringes that are ˜1 nm apart from the input pulse and the reference pulse, the finer spectral modulation due to the train of post-pulses are also clearly seen in the measured spectral interferogram.

As shown and described above, preferred apparatus 10 and method have many advantages over other laser contrast techniques. Firstly, a 35 dB spectral measurement is very straightforward to obtain without a stringent requirement on the setup, CCD and alignment scheme. Secondly, the preferred apparatus 10 and method are configured to measure the spectrum, eliminating any worries about the spatial uniformity of the laser beam profile, which can be a significant problem when the laser contrast is directly measured in time domain. Measurement of the spectral domain also eliminates the need for a spatial filter for removing the diffraction effects during the implementation greatly relaxing the alignment requirements. Thirdly, as both the input and reference pulses are at a fundamental wavelength, a CW beam can be used for entire alignment process of the preferred apparatus 10 and method. Fourthly, the preferred apparatus 10 and method do not include any significant complicated post processing and data analysis save for a Fourier transformation. And lastly, the preferred apparatus 10 and method do not require any approximations during the entire measurement and data retrieval process, thereby ensuring the accuracy and completeness of the retrieved data.

An alternative embodiment preferably implements the one or more aspects of the preferred apparatus and/or method in a computer-readable medium storing computer-readable instructions. The instructions are preferably executed by computer-executable components. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively, or additionally, be executed by any suitable dedicated hardware device. The computer-executable component is preferably designed for any suitable computing platform.

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
splitting a first laser pulse into an input beam and a reference beam;
directing the reference beam to a non-linear optical assembly;
detecting the input beam and the reference beam at a detector; and
cross-correlating the input beam and the reference beam to characterize the first laser pulse.

2. The method of claim 1, wherein cross-correlating the input beam and the reference beam comprises a fourth order cross correlation.

3. The method of claim 1, wherein splitting the first laser pulse into an input beam and a reference beam comprises splitting the first laser pulse with a 10/90 beam splitter.

4. The method of claim 1, wherein an intensity of the first laser pulse measures approximately 10²⁰ W/cm² intensity per pulse.

5. The method of claim 1, wherein the non-linear optical assembly comprises one or more non-linear optical elements comprising one of: a beam splitter, a type I BBO crystal, a type II BBO crystal, a partially reflective mirror, a totally reflective mirror, a frequency-selecting optical element, a lens, or a gradient.

6. An apparatus comprising:
a high-power laser;
a beam splitter;
a non-linear optical assembly configured to cube an intensity profile of an incident beam;
a detector optically configured to receive an input beam from the beam splitter and a reference beam from the non-linear optical assembly; and
a controller configured to calculate a fourth order cross correlation of the input beam and the reference beam to characterize the high-power laser.

7. The apparatus of claim 6, wherein the high-power laser provides approximately 10²⁰ W/cm² intensity per pulse.

8. The apparatus of claim 6, wherein the non-linear optical assembly comprises one or more non-linear optical elements comprising one of: a beam splitter, a type I BBO crystal, a type II BBO crystal, a partially reflective mirror, a totally reflective mirror, a frequency-selecting optical element, a lens, or a gradient.

9. The apparatus of claim 6, wherein the beam splitter comprises a 10/90 beam splitter.

10. The apparatus of claim 6, wherein the non-linear optical assembly comprises a first 10/90 beam splitter; a second 10/90 beam splitter; a 2 mm thick type I BBO crystal; three consecutive dichroic mirrors; and a 2 mm thick type II BBO crystal.
